(19) United States
(12) Patent Application Publication
(10) Pub. No.: US 2006/0084422 A1
(43) Pub. Date: Apr. 20, 2006

(54) Control glove

(75) Inventors: Chin-Tang Huang, Tainan Hsien (TW); Ching-Tu Shih, Changhua Hsien (TW)

Correspondence Address: BACON & THOMAS, PLLC, 625 SLATERS LANE, FOURTH FLOOR, ALEXANDRIA, VA, 22314, US

(73) Assignee: Tonic Fitness Technology, Inc., Tainan Hsien (TW)

(21) Appl. No.: 10/968,147

(22) Filed: Oct. 20, 2004

(51) Int. Cl. H04M 3/00

(52) U.S. Cl. 455/420

(57) ABSTRACT

A control glove includes a contact point provided on the thumb and the four fingers of the glove and a controller. The contact point on the thumb is a common point, and the contact points on the four fingers respectively direct one it e m of operations different from one another. All the contact points are electrically connected with the controller that contains a transmitter for transmitting signals to a receiver provided in a fitness machine or appliance. Then the thumb is moved by a user to optionally contact one of the four fingers to let their contact points contact each other to let electricity get through, and the controller transmits a signal of the selected item of operations to the receiver of the fitness machine or appliance to change the ongoing operation to the selected item of opeation.

### BACKGROUND OF THE INVENTION

1. Field of the Invention

This invention related to a control glove, particularly to one for five fingers of a user to extend therein and moving the thumb to optionally contact one of the four fingers for controlling to change the item of operations of a fitness machine.

2. Description of the Prior Art

When a person makes fitness exercise on a fitness machine or appliance and wants to change the ongoing item of operations of the fitness machine or appliance during exercising, for example, to change the speed of the jogging machine or the inclining angle of a stepping board, the person may not be able to easily handle a switch on the machine or appliance, as the switch is stationary, but the person is moving his body, causing instability of the center of gravity of the body, so that the person may lose control to incline or fall down from the machine or appliance. Therefore, this control glove has been devised to get rid of the above-mentioned disadvantage of the convention fitness machine or appliance.

### SUMMARY OF THE INVENTION

The purpose of the invention is to offer a control glove for controlling the different operations of a fitness machine or appliance, by using the thumb of the glove moved by a user for optionally contacting with one of the four fingers of a hand and accordingly controlling ongoing operation of the fitness machine.

The feature of the invention is a contact point respectively provided on the thumb and four fingers of a hand, and the contact point on the thumb is for a common use, and the contact points on the four fingers direct an item of operations different from one another. Then the contact points are all electrically connected with a controller, which includes a transmitter to send signals to a receiver provided in a fitness machine or appliance. Then the control glove is used by a user (exerciser), with the thumb optionally contacting with one of the other fingers, so the contact points of the thumb and one of the fingers are connected to let electricity get through to transmit an item of operation directed by one of the fingers to the receiver of the fitness machine or appliance, which then changes the ongoing operation to the selected item of operation.

### BRIEF DESCRIPTION OF DRAWINGS

This invention will be better understood by referring to the accompanying drawings, wherein:

FIG. 1 is a perspective view of a control glove in the present invention;

FIG. 2 is a front view of the control glove in the present invention;

FIG. 3 is a perspective view of the thumb contacting the index finger in the present invention;

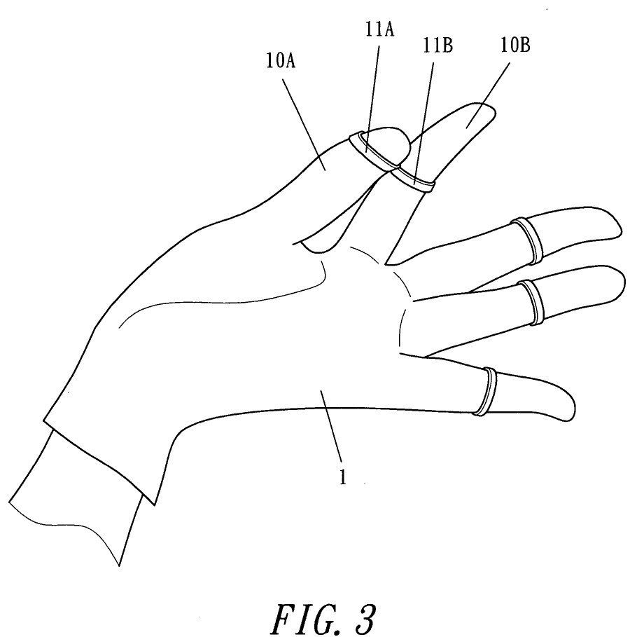

FIG. 4 is a perspective view of the thumb contacting the middle finger in the present invention;

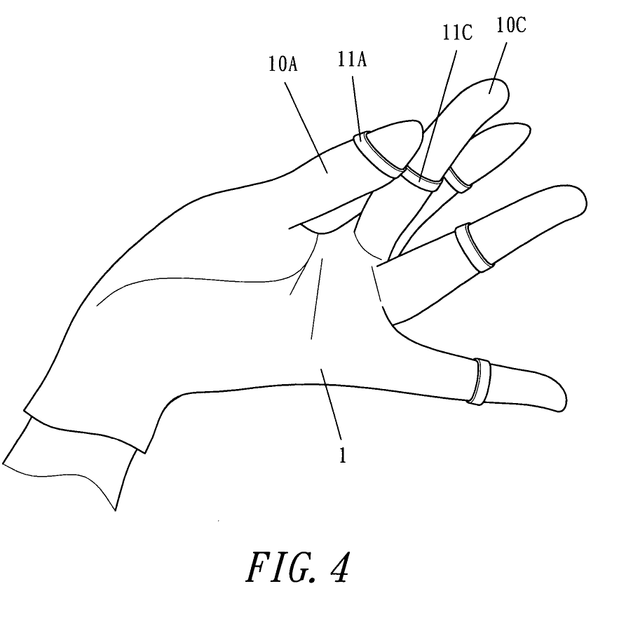

FIG. 5 is a perspective view of the thumb contacting the third finger in the present invention; and,

FIG. 6 is a perspective view of the thumb contacting the little finger in the present invention.

### DETAILED DESCRIPTION OF THE PREFERRED EMBODIMENT

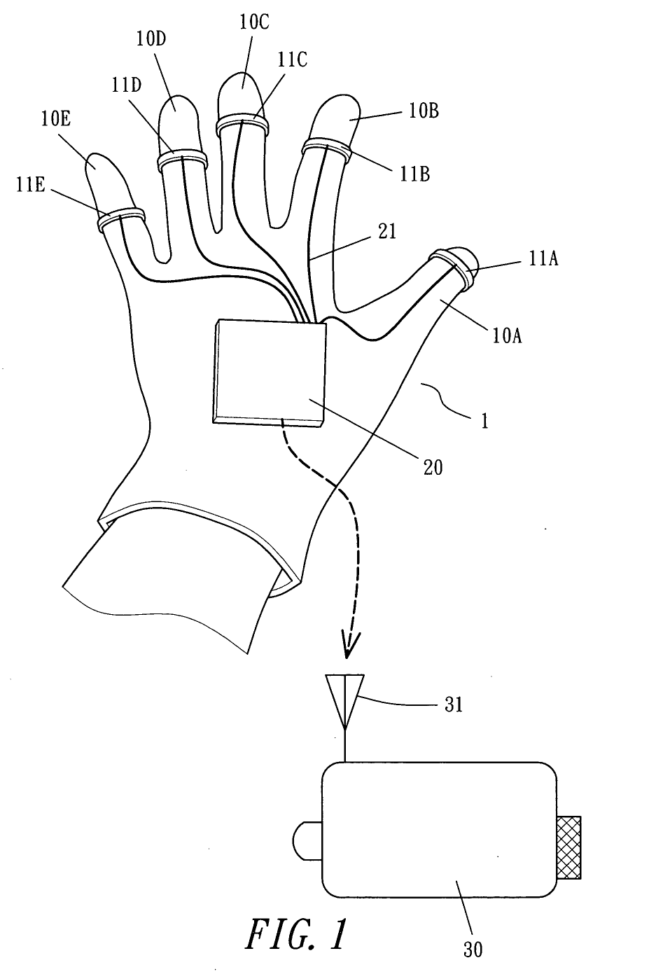

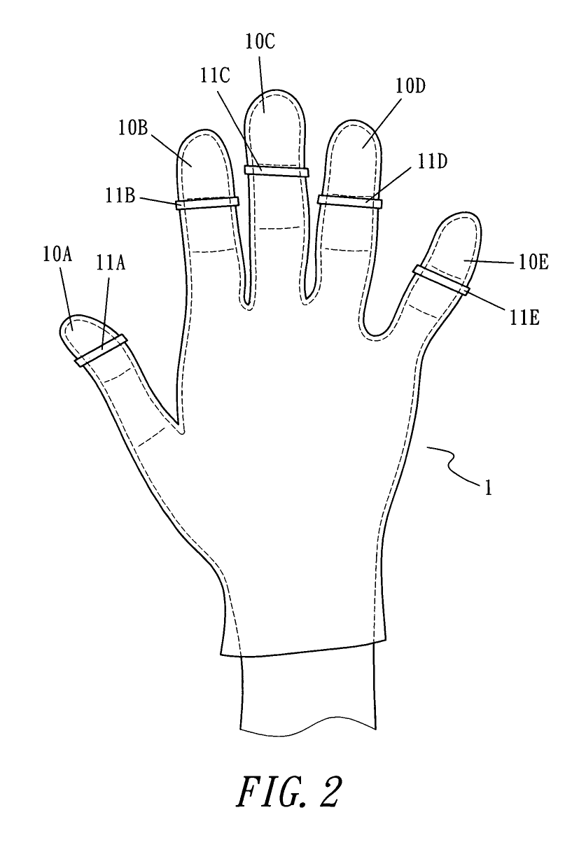

A preferred embodiment of a control glove in the present invention, as shown in FIGS. 1 and 2, includes a thumb (10A), an index finger (10B), a middle finger (10C), a third finger (10D) and a little finger (10E). The thumb and each finger have a contact point, and the thumb (10A) has a contact point (11A), the index finger (11B), the middle finger (11C), the third finger (11D) and the little finger (11E). Then all of the contact points (11A), (11B), (11C), (11D) and (11E) are electrically connected with a controller 20 fixed on the control glove 1 with wires 21, and each contact point directs an item of operations for a fitness machine via the controller 20, which comprises a transmitter for sending a signal of the selected item of operation to a receiver 31 provided in a fitness machine or appliance 30 for receiving the signal from the controller 20. Then the fitness machine 30 changes the ongoing operation to the selected item of operations accordingly

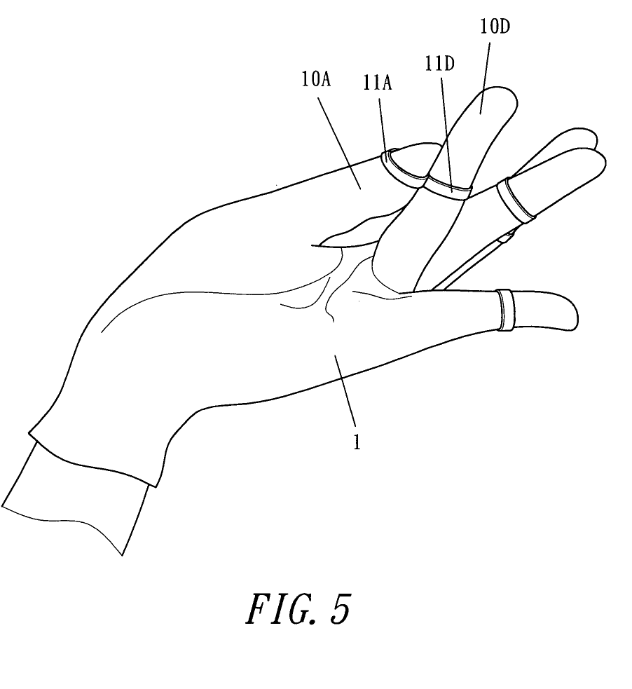

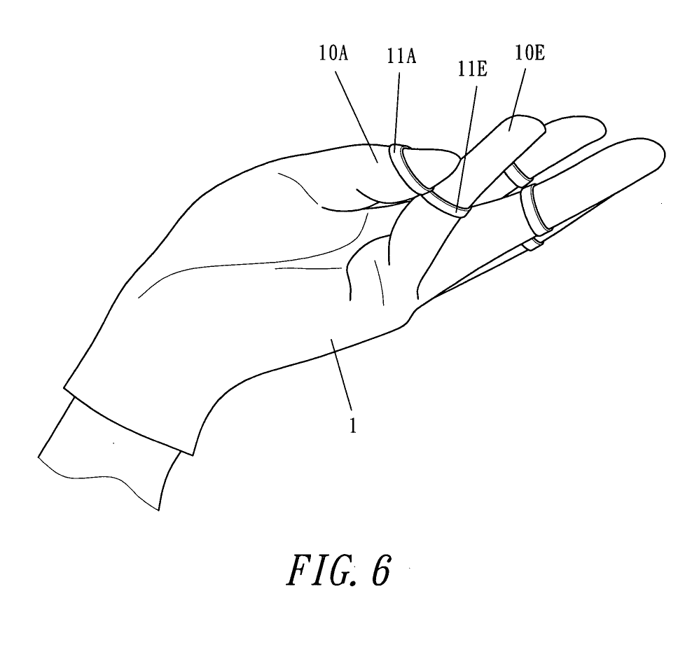

In using, a user wears the control glove 1, and moves the thumb (10A) to contact one of the other fingers, for example, the index finger (10B) so as to let the contact point (11A) of the thumb contact the contact point (11B) of the index finger. The controller 20 may transmit the signal of the datum of the selected item of operations directed by the index finger (10B) to the receiver 31 of the fitness machine 30. Then the fitness machine 30 changes the on-going operation to the operation directed by the index finger (10B). Similarly, if a user moves the thumb (10A) to contact the middle finger (10C) so as to let the contact point (11A) o f the thumb contact the contact point (11C) of the middle finger, the controller 20 sends a signal of the selected item of operations to the fitness machine 30 to change the on-going operation to the operation directed by the middle finger. So do the third finger (10D) and the little finger (10E) direct their item of operations by contact with the thumb (10A), as shown in FIGS. 5 and 6.

Next, when the control glove 1 is applied to a fitness machine 30 such as a jogging machine, the contact point (11B) of the index finger (10B) controls a stepping board to incline down, and the contact point (11C) of the middle finger (10C) controls the stepping board to incline up, and the contact point (11D) of the third finger (10D) controls the moving band to reduce its speed, and the contact point (11E) of the little finger (10E) controls the moving band to increase its speed.

In general, a user can move this control glove 1 and optionally choose the thumb (10A) to contact one of the four fingers to get the needed operation of a fitness machine with easiness during making exercise, not needing to move a hand to handle a switch as needed in the conventional fitness machine.

While the preferred embodiment of the invention has been described above, it will be recognized and understood that various modifications may be made therein and the appended claims are intended to cover all such modifications that may fall within the spirit and scope of the invention.

What is claimed is:

1. A control glove provided with a contact point respectively on the thumb and each of the four fingers of said glove, each said contact point electrically connected with a controller fixed on said glove, said controller containing a transmitter for transmitting signals to a receiver provided in a fitness appliance or machine for controlling said fitness appliance or machine to change an ongoing item of operation to the selected item of operation directed by any of said fingers, said contact point of the thumb functioning as a common point, the four fingers respectively directing one item of opeation different from one another, said controller transmitting a signal of the selected item of operation to the receiver of said fitness machine or appliance when the thumb is moved to contact one of said four fingers to let their contact points contact each other to let electricity get through.

2. The control glove as claimed in claim 1, wherein when said control glove is applied to a jogging machine, the four fingers of said control glove respectively direct the inclining up and down of a stepping board and increasing and reducing of the speed of a moving band.
